(19) United States
(12) Patent Application Publication
(10) Pub. No.: US 2019/0309706 A1
(43) Pub. Date: Oct. 10, 2019

(54) ROCKET ENGINE COMBUSTION CHAMBER WITH FINS OF VARYING COMPOSITION

(71) Applicant: ARIANEGROUP SAS, Paris (FR)

(72) Inventor: Didier GUICHARD, Menilles (FR)

(73) Assignee: ARIANEGROUP SAS, Paris (FR)

(21) Appl. No.: 16/309,336

(22) PCT Filed: Jun. 8, 2017
(86) PCT No.: PCT/FR2017/051442

§ 371 Date: Dec. 12, 2018

(30) Foreign Application Priority Data
Jun. 13, 2016 (FR) 1655412

(51) Int. Cl. F02K 9/64

(52) U.S. Cl. CPC F02K 9/64; F05D 2300/172

(57) ABSTRACT

A rocket engine combustion chamber (1) extending along a longitudinal axis A may have a longitudinal envelope, the longitudinal envelope having a longitudinal inner wall (10) made of a first alloy, which is a copper alloy, and that is extended over its radially outer face (15) by a plurality of fins (20) extending radially outwards, each of the fins presenting a proximal portion (22), a middle portion (25), and a distal portion (28), and having an outer shell (30) surrounding the inner wall (10) and the fins (20), the shell (30) being made of a third alloy distinct from the first alloy. The proximal portion (22) is made of the first alloy, and the distal portion (28) is made of a second alloy that is an alloy distinct from the first alloy.

The present invention relates to a rocket engine combustion chamber extending along a longitudinal axis A and comprising a longitudinal envelope comprising a longitudinal inner wall made of a first alloy, which is a copper alloy, and that is extended over its radially outer face by a plurality of fins extending radially outwards, each of the fins presenting a proximal portion, a middle portion, and a distal portion, and comprising an outer shell surrounding the longitudinal inner wall and the fins, the shell being made of a third alloy distinct from the first alloy.

In the description below, the terms “inner” and “outer” respectively indicate a portion that is situated radially inside or outside or that is oriented radially towards the inside or the outside relative to the longitudinal axis of the combustion chamber.

In rocket engines, the envelope of the combustion chamber comprises a longitudinal wall that extends longitudinally along a longitudinal axis A, the longitudinal axis A being substantially the axis of revolution of the combustion chamber. The longitudinal wall of the chamber presents fins on its outer face that extend radially outwards from said longitudinal wall and that extend along that wall. A shell serves to surround the longitudinal wall from the outside, coming into contact with the radially outer ends (distal ends) of the fins so as to close the gaps between the fins. Thus, each gap between two adjacent fins forms a channel that might possibly be open only at its longitudinal ends.

This array of channels is to receive a cooling liquid, e.g. liquid hydrogen, that, by flowing along these channels, serves to cool the longitudinal wall, which is subjected on its inside face to high temperatures by the combustion that takes place inside the combustion chamber.

In order to maximize this exchange of heat through the longitudinal wall, the longitudinal wall and the fins are made of a copper alloy.

In addition to its role of closing the channels, the shell serves to provide the combustion chamber with structural strength, since the copper alloy of the longitudinal wall presents mechanical characteristics that are not sufficient for achieving sufficient mechanical strength in operation. The shell is thus made of an alloy that is stronger than copper, e.g. an alloy based on nickel or on iron.

Nevertheless, fastening the shell on the distal ends of the fins presents difficulties associated with assembling together two materials having properties that are substantially different. Specifically, the copper alloys used are not weldable with, or are difficult to weld with, the alloy of the longitudinal shell. Thus, it is impossible or difficult to weld the fins and the shell together with satisfactory strength.

It is possible to braze the shell on the fins, but that method is complex (brazing in an enclosure) and not very reliable (large differential stresses between the copper alloy and the alloy of the shell).

It is also possible to close the channels by electrolytic deposition, or by thermal spraying, or by any other type of coating method. Nevertheless, it is necessary to begin by filling the channels so that after they have been closed, the insert can be eliminated and thereby guarantee that the channels are not obstructed; this leads to fabrication cycles that are very lengthy with numerous operations that are potentially sources of defects at the connection.

The present invention seeks to remedy those drawbacks.

The invention seeks to propose a rocket engine combustion chamber in which the wall is made of copper alloy and in which the fins are covered by a shell in such a manner that the gaps between the fins form channels, with fabrication thereof being made easier, and that also presents satisfactory mechanical strength.

This object is achieved by the fact that said proximal portion of at least one fin, preferably of each of the fins, is made of said first alloy, and said distal portion of said fin is made of a second alloy that is an alloy distinct from the first alloy, said middle portion of said fin between said proximal portion and said distal portion presenting a composition that varies gradually with radial distance from said longitudinal axis A from 100% of first alloy at the interface between said proximal portion and said middle portion, to 100% of second alloy at the interface between said middle portion and said distal portion, said second alloy presenting weldability with said third alloy that is greater than the weldability of said first alloy with the third alloy, and/or presenting mechanical strength that is greater than the mechanical strength of said first alloy.

By means of these provisions, it is possible to weld the outer shell onto the fins, thereby facilitating fabrication of the combustion chamber. Alternatively, or in addition, the fins may present mechanical strength that is greater than that of fins made entirely out of copper alloy.

The invention also provides a method of fabricating a rocket engine combustion chamber.

According to the invention, the method comprises the following steps:
making a blank out of the first alloy, the blank comprising a first portion including at least the longitudinal inner wall and a second portion including at least the proximal portion of each of the fins;
depositing a material on at least some zones of the radially outer surface of the second portion in such a manner as to form a third portion including at least the middle portion of each of said fins, the composition of said material varying gradually with radial distance from said longitudinal axis A from 100% first alloy at the interface between said second portion and said third portion, to 100% of a second alloy at the radially outer end of said third portion, the second alloy being an alloy distinct from said first alloy;
depositing said second alloy on at least some zones of the radially outer surface of the third portion so as to form a fourth portion including at least said distal portion of each of said fins; and
surrounding said fourth portion with said outer shell made of the third alloy, said second alloy presenting weldability with said third alloy that is greater than the weldability of said first alloy with the third alloy, and/or presenting mechanical strength that is greater than the mechanical strength of said first alloy.

The invention can be well understood and its advantages appear better on reading the following detailed description of an embodiment given by way of non-limiting example. The description refers to the accompanying drawing, in which:

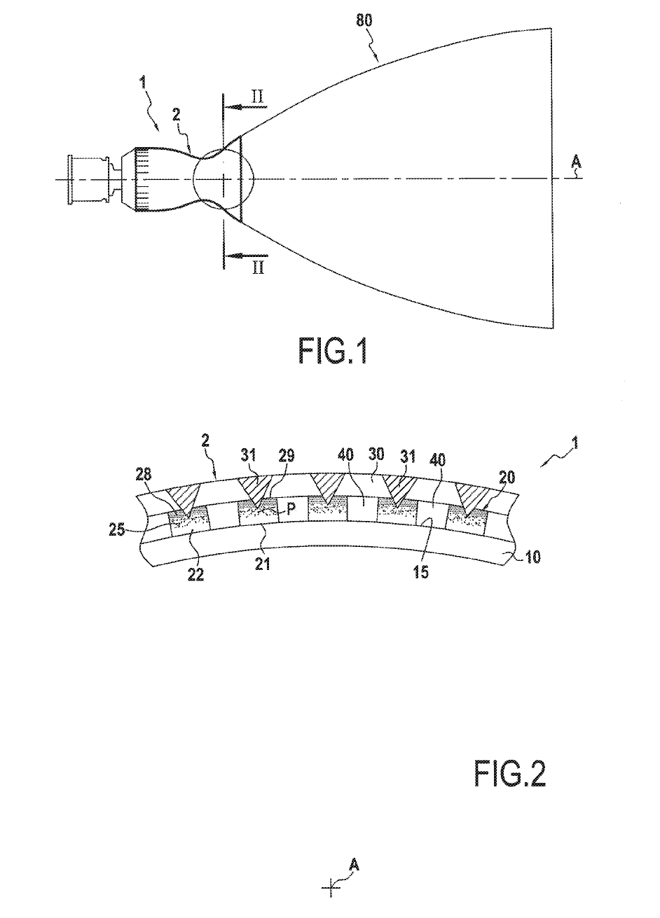

FIG. 1 is a longitudinal section view of a rocket engine propulsion chamber for a rocket engine having a combustion chamber of the invention; and

FIG. 2 is a cross-section of the combustion chamber of the invention.

FIG. 1 shows a propulsion chamber in longitudinal section. The propulsion chamber includes a combustion chamber 1 of the invention together with a diverging portion 80. The combustion chamber 1 is of substantially annular shape, and it extends along a longitudinal axis A.

The combustion chamber 1 is surrounded by a longitudinal envelope 2 comprising a longitudinal wall comprising in full or in part a longitudinal inner wall 10. This inner wall 10 is made of a first alloy, which is a copper alloy.

The inner wall 10 of the combustion chamber 1 presents fins 20 on its outer face 15, which fins extend the inner wall 10 radially outwards and extend along the inner wall 10, as shown in FIG. 2, which is a cross-section of the combustion chamber 1.

The gap between any two adjacent fins 20 forms a channel 40 that extends along the wall. By way of example, each channel 40 is oriented in the longitudinal direction (longitudinal axis A), or by way of example it could be helical around the longitudinal axis A.

By way of example, each fin 20 presents a section that is rectangular, and by way of example each channel 40 presents a section that is rectangular, as shown in FIG. 2. Alternatively, the fins 20 and the channels 40 could present sections of other shapes.

By way of example, the fins 20 are of constant height that is identical from one fin 20 to another.

Each of the fins 20 thus presents a proximal portion 22, a middle portion 25, and a distal portion 28. The proximal portion 22 is the portion closest to the outer face 15 and to the longitudinal axis A. The distal portion 28 is the portion further from the longitudinal axis A, and includes the radially outer end 29 of the fin 20. The middle portion 25 is situated between the proximal portion 22 and the distal portion 28.

In the invention, the middle portion 25 presents a composition that varies gradually with the radial distance from the longitudinal axis A, from 100% of the first alloy at the interface between the proximal portion 22 and the middle portion 25, to 100% of a second alloy at the interface between the middle portion 25 and the distal portion 28, the distal portion 28 being constituted by this second alloy.

For example, this gradual variation may be linear as a function of distance from the longitudinal axis A.

The middle portion 25 of a fin 20 is situated at a certain distance from the base 21 of the fin 20, which base 21 is where the proximal portion 22 of the fin 20 meets the outer face 15 of the inner wall 10. This distance is defined as the radial distance between the geometrical center of the middle portion 25 and the base 21.

This distance is constant all along the length of the fin 20.

This distance is identical for each of the fins 20.

The thickness (radial height) of each middle portion 25 is constant all along the length of the fin 20 and is identical for each of the fins 20. Alternatively, this thickness of the middle portion (25) of varying composition may also vary longitudinally, so as to be adapted locally to the thermomechanical stresses that vary with longitudinal position along the combustion chamber.

The second alloy is an alloy that is different from the first alloy. By way of example, the second alloy is an alloy that is not a copper alloy.

The combustion chamber 1 also has an outer shell 30 surrounding the longitudinal inner wall 10 and the fins 20 (FIG. 2). The shell 30 is annular and it is situated radially outside the fins 20. The shell 30 is made of a third alloy that is different from the first alloy.

In a first variant of the invention, the second alloy presents weldability with the third alloy that is greater than the weldability of the first alloy with the third alloy.

It is thus possible without difficulty to weld the shell 30 to the distal ends 29 of the fins 20. When the shell 30 is welded onto the fins 20, the mechanical strength of the combustion chamber 1 is greater than when the shell 30 is not welded onto the fins 20, in particular when the connection is made by the adhesion of an electrolytic deposit at the tops of the fins. Each channel 40 is thus a closed channel. Each gap between any two adjacent fins 20 thus forms a closed channel 40. The term “closed channel” is used to mean a channel that is optionally open only at its ends, and that has a side wall that is continuous.

In the other variant of the invention, the mechanical strength of the second alloy is stronger than that of the first alloy. Thus, the stiffness of the combustion chamber 1 is increased compared to when the fins 20 are made entirely out of the first alloy.

Under such circumstances, the shell 30 need not be fastened on the distal ends 29. Thus, gaps exist between the ends 29 of the distal portions 28 of the fins 20 and the shell 30 such that the gaps between the fins 20 form channels 40 that are open.

For example, the shell 30 may be fastened on a component of the combustion chamber 1 at at least one of its longitudinal ends.

By way of example, the shell 30 may be fastened to respective components of the combustion chamber 1 at both of its longitudinal ends, i.e. at its upstream end and at its downstream end.

In the invention, the second alloy may present both weldability with the third alloy that is greater than the weldability of the first alloy with the third alloy, and may also present mechanical strength that is greater than the mechanical strength of the first alloy.

For example, the second alloy may be a nickel alloy.

Advantageously, the third alloy and the second alloy are identical, thus providing better weldability between these two alloys.

Advantageously, for each of the fins 20, the radial distance between the middle portion 25 and the base 21 of the fins 20 in a transverse plane P of the fins 20 varies as a function of the longitudinal position of this plane P along the combustion chamber.

By way of example, under such circumstances, the thickness (radial height) of each middle portion 25 remains constant with longitudinal position of the plane P.

For example, this radial distance decreases on going from upstream towards the downstream end of the combustion chamber. “Upstream” and “downstream” are defined relative to the flow direction of gas in normal operation of the combustion chamber 1, i.e. away from the fuel and oxidizer injectors towards the opening of the combustion chamber and the diverging portion 80.

For example, further upstream, this distance is equal to the height of the fin 20 minus some minimum distance corresponding to the depth of the welding 31 in the fin 20, i.e. the fin 20 is made entirely out of the first alloy except for its outermost portion in which the weld 31 is made. This distance becomes zero at the furthest downstream end, i.e. the fin is made entirely out of the second alloy.

Thus, along the combustion chamber 1, thermal conduction taking place via the fins 20 is at a maximum upstream and at a minimum downstream, since the first alloy presents thermal conduction that is greater than that of the second alloy. The cooling of the inner wall 10 is thus small at the downstream end of the combustion chamber 1, thereby avoiding or minimizing the formation of liquid water inside the downstream portion of the combustion chamber, where the heat flux coming from the combustion gas is at its lowest as a result of the drop in pressure in the diverging portion of the combustion chamber. Specifically, in the prior art, for certain combustion chambers, the wall temperature can be lower than ambient temperature, so the boundary layer of the combustion gas (which gas is essentially steam when the combustion is between oxygen and hydrogen) can become liquid water, which can lead to problems for the operation of the diverging portion 80.

The invention also provides a method of making a combustion chamber as described above.

In a first example, this method comprises the following steps:

a) using a deposition method or a traditional forging and machining method to make a blank containing the inner wall 10 and the proximal portions 22 of the fins 20. This blank is made of a first alloy;

b) depositing a material on the radially outer ends of each of the proximal portions 22 so as to form the middle portions 25 of each of said fins 20, the composition of the material varying gradually with radial distance from the longitudinal axis A from 100% of the first alloy at the interface between the proximal portion 22 and the middle portion 25, to 100% of a second alloy at the radially outer end of the middle portion 25, this second alloy being an alloy that is distinct from the first alloy;

c) depositing the second alloy on the radially outer ends of each of the middle portions 25 so as to form the distal portions 28 of each of the fins 20;

d) surrounding the longitudinal inner wall 10 and the fins 20 with an outer shell 30 made of a third alloy distinct from the first alloy, the second alloy presenting weldability with the third alloy that is greater than the weldability of the first alloy with the third alloy, and/or presenting mechanical strength that is greater than the mechanical strength of the first alloy.

e) then welding on the outer shell 30, which may advantageously be made up of two half-shells or of a plurality of distinct portions, the welding being to the tops of the fins 20 by transparency, using a welding method that may for example be laser welding or electron beam welding. The various portions of the outer shell 30 are also assembled together by welding during the same operation and using the same welding method, or else in a separate step, possibly using some other welding method (e.g. TIG welding).

By way of example, in steps a), b), and c), the deposition is performed by spraying powder. This may involve thermal spraying, using a plasma or a flame, or cold spraying (generally known as “cold gas spraying”), or indeed laser deposition (generally known as “laser metal deposition”). Thus, the middle portion 25 is easier to make since it suffices to increase the proportion of the second alloy relative to the first alloy progressively while this middle portion 25 is being made. Thus, the proportion of the second alloy increases progressively from 0% at the beginning of spraying in order to bring the middle portion 25 upto 100% at the end of spraying, with the proportion of the first alloy decreasing in parallel from 100% to 0%.

In order to make the proximal portion 22, only the powder of the first alloy is deposited, and in order to make the distal portion 28, only the powder of the second alloy is deposited.

In a second example, the method comprises the following steps:

a) using a deposition method or a traditional forging and machining method to make an axisymmetric blank comprising the inner wall 10 together with a second portion that is coaxial, continuous, and axisymmetric, possessing a height that corresponds to the height desired for the proximal portions 22 of the fins 20. This blank is made of the first alloy;

b) depositing a layer of material on the outer surface of the second portion so as to form a third portion that is coaxial, continuous, and axisymmetric, possessing a height corresponding to the height desired for the middle portions 25 of the fins 20, the composition of the material varying gradually with radial distance from the longitudinal axis A from 100% first alloy at the interface between the second layer 22 and the third layer 25, to 100% of a second alloy at the outer surface of the third portion 25, the second alloy being an alloy distinct from the first alloy;

c) depositing a layer of the second alloy on the outer surface of the third portion so as to form a fourth portion that is coaxial, continuous, and axisymmetric possessing a height corresponding to the height desired for the middle portion 25 of the fins 20;

d) machining channels 40 in the second, third, and fourth portions so as to form the fins 20;

e) surrounding the longitudinal inner wall 10 and the fins 20 with an outer shell 30 made of a third alloy distinct from the first alloy, the second alloy presenting weldability with the third alloy that is greater than the weldability of the first alloy with the third alloy, and/or presenting mechanical strength that is greater than the mechanical strength of the first alloy; and

f) then welding the outer shell 30, which may advantageously be made up of two half-shells or of a plurality of distinct portions, the welding being to the tops of the fins 20 by transparency, using a welding method that may for example be laser welding or electron beam welding. The various portions of the outer shell 30 are also assembled together by welding during the same operation and using the same welding method, or else in a separate step, possibly using some other welding method (e.g. TIG welding).

1. A rocket engine combustion chamber extending along a longitudinal axis A and comprising a longitudinal envelope, the longitudinal envelope comprising:
an inner longitudinal wall made of a first alloy, which is a copper alloy, and that is extended over its radially outer face by a plurality of fins extending radially outwards, each of said fins presenting a proximal portion, a middle portion, and a distal portion; and
an outer shell surrounding that said longitudinal inner wall and said fins, said shell being made of a third alloy distinct from the first alloy;
wherein said proximal portion of at least one fin is made of said first alloy, and said distal portion of said fin is made of a second alloy that is an alloy distinct from the first alloy, said middle portion of said fin between said proximal portion and said distal portion presenting a composition that varies gradually with radial distance from said longitudinal axis A from 100% of first alloy at the interface between said proximal portion and said middle portion, to 100% of second alloy at the interface between said middle portion and said distal portion, said second alloy presenting weldability with said third alloy that is greater than the weldability of said first alloy with the third alloy, and/or presenting mechanical strength that is greater than the mechanical strength of said first alloy.

2. A combustion chamber according to claim 1, characterized in that said second alloy and said third alloy are identical.

3. A combustion chamber according to claim 1, characterized in that said second alloy is a nickel alloy.

4. A rocket engine combustion chamber according to claim 1, characterized in that said shell is welded to the ends of the distal portions of said fins in such a manner that each gap between any two adjacent fins forms a closed channel.

5. A rocket engine combustion chamber according to claim 1, characterized in that gaps exist between the ends of the distal portions of said fins and said shell in such a manner that the gaps between said fins form open channels.

6. A rocket engine combustion chamber according to claim 5, characterized in that said shell is fastened on a component of said combustion chamber at at least one of its longitudinal ends.

7. A rocket engine combustion chamber according to claim 1, characterized in that for each of said fins, the radial distance of said middle portion to the base of said fin in a transverse plane P of said fin varies as a function of the longitudinal position of the plane P along said combustion chamber.

8. A fabrication method for fabricating a rocket engine combustion chamber extending along a longitudinal axis A and comprising a longitudinal envelope, the longitudinal envelope comprising:
a longitudinal inner wall made of a first alloy, which is a copper alloy;
a plurality of fins extending radially outwards from the radially outer face of the longitudinal inner wall, each of said fins presenting a proximal portion, a middle portion, and a distal portion; and
an outer shell surrounding that said longitudinal inner wall and said fins, said shell being made of a third alloy distinct from the first alloy;
said method comprising the following steps:
making a blank out of the first alloy, the blank comprising a first portion including at least the longitudinal inner wall and a second portion including at least the proximal portion of each of the fins;
depositing a material on at least some zones of the radially outer surface of the second portion in such a manner as to form a third portion including at least the middle portion of each of said fins, the composition of said material varying gradually with radial distance from said longitudinal axis A from 100% first alloy at the interface between said second portion and said third portion to 100% of a second alloy at the radially outer end of said third portion, the second alloy being an alloy distinct from said first alloy;
depositing said second alloy on at least some zones of the radially outer surface of the third portion so as to form a fourth portion including at least said distal portion of each of said fins; and
surrounding said fourth portion with said shell made of the third alloy, said second alloy presenting weldability with said third alloy that is greater than the weldability of said first alloy with the third alloy, and/or presenting mechanical strength that is greater than the mechanical strength of said first alloy.

9. A fabrication method according to claim 8, wherein the channel is then welded by transparency to the tops of the fins.
